(19) United States
(12) Patent Application Publication
(10) Pub. No.: US 2012/0246189 A1
(43) Pub. Date: Sep. 27, 2012

(54) COMPARING HISTOGRAMS

(76) Inventors: Malu Castellanos, Sunnyvale, CA (US); Perla Ruiz, Hermosillo (MX); Umeshwar Dayal, Saratoga, CA (US)

(21) Appl. No.: 13/070,056

(22) Filed: Mar. 23, 2011

(51) Int. Cl. G06F 17/30

(52) U.S. Cl. 707/769; 707/E17.014

(57) ABSTRACT

First data indicative of a first histogram and second data indicative of a second histogram are received and processed to determine quantitative differences between the first and second histograms. Third data is generated, which is indicative of the result of the quantitative differences.

### TECHNICAL FIELD OF THE INVENTION

The disclosure generally relates to comparing histograms.

### BACKGROUND

A histogram is an estimate of the probability distribution of a continuous variable based on a given set of data. The histogram may be graphically represented by adjacent rectangles, or bars 12, as depicted by an exemplary histogram 10 in FIG. 1. The bars 12 represent tabular frequencies of the histogram 10 over discrete intervals called “bins.” As illustrated in FIG. 1, the bins are not necessarily uniform, as bars 12a and 12b, for example, have different bin sizes. In general, the area of a given bar 12 is equal to the frequency of the observation in the associated bin. The height of the bar 12 represents the frequency density of the bin. In other words, the height of a bar 12 is equal to the frequency divided by the width of the bin.

### BRIEF DESCRIPTION OF THE DRAWING

FIG. 1 is an illustration of a histogram.

FIG. 2 is a schematic diagram of a computer system according to an example implementation.

FIGS. 3 and 9 are flow diagrams depicting techniques to compare histograms according to example implementations.

FIGS. 4, 5, 6 and 8 illustrate histograms comparisons according to example implementations.

FIG. 7 is an illustration of a graphical user interface according to an example implementation.

### DETAILED DESCRIPTION

In accordance with exemplary implementations, systems and techniques are disclosed herein to facilitate the comparison of histograms. Such a comparison may be used in a time lapse analysis, for example, for purposes of evaluating the extent to which the probability distribution of a continuous variable (represented by two histograms at two different times) has changed over time. As a more specific example, the comparison may be useful for such purposes as performing a root cause analysis of changes in the query execution plan that is produced by a database management system (DBMS).

In this manner, a DBMS manages data stored in repositories called databases and allows users to formulate queries that target selected subsets of the stored data. For example, a query may be directed to obtaining the names of employees working on projects in the oil & gas industry. To respond to such queries, the DBMS may include an optimizer that receives a query (or a compiled version of it) and produces an execution plan. This execution plan is formulated by the DBMS to optimize execution of the query and typically is a tree of operators, which instructs an executor of the DBMS regarding how to execute the query. For example, the execution plan may select the particular operators for the query and the order in which these operators are applied.

To produce the execution plan, the optimizer estimates the size of the intermediate results to determine which operators are more efficient; and for purposes of estimating the size of the intermediate results, the optimizer determines the size of the input data. For this purpose, the DBMS uses a histogram (a histogram generated by the DBMS, for example) for each column of each table in the database as well as for some groups of table columns.

The histogram may be produced using lossy compression-generated data, which means that the histogram for a given table column, for example, does not represent the frequency of each value in the table column. Instead, a histogram that is derived from lossy compression-generated data may not include all of the frequency values for a given group of data but rather produce a single frequency for the whole group. When the optimizer of the DBMS requests the frequency of a given value, only an estimate of the frequency is returned since the individual frequencies have been lost.

As the input data changes, the histograms may become obsolete, and the DBMS may be instructed by a DBMS user to recalculate the histograms, and these recalculated histograms may, in turn, alter the execution plans produced by the DBMS. With the use of the histogram comparison techniques and systems that are disclosed herein, a user may explore if the DBMS plans have changed from one execution to another due to an actual change of the data distribution statistics.

The techniques and systems described herein automatically compare two histograms and generate one or multiple output files that show how different aspects of the histograms compare with each other. The comparison could be between a previously-generated histogram of an attribute and a more recently-generated histogram of the same attribute. However, it is noted that the histogram comparison is not limited to the comparison of newer and older histograms for the same attribute, as in general, the systems and techniques that are disclosed herein may be used to compare any two histograms. It is assumed that either the full, lossless set of data used to generate the previously-generated histogram or a lossy set of data corresponding to the histogram itself has been saved.

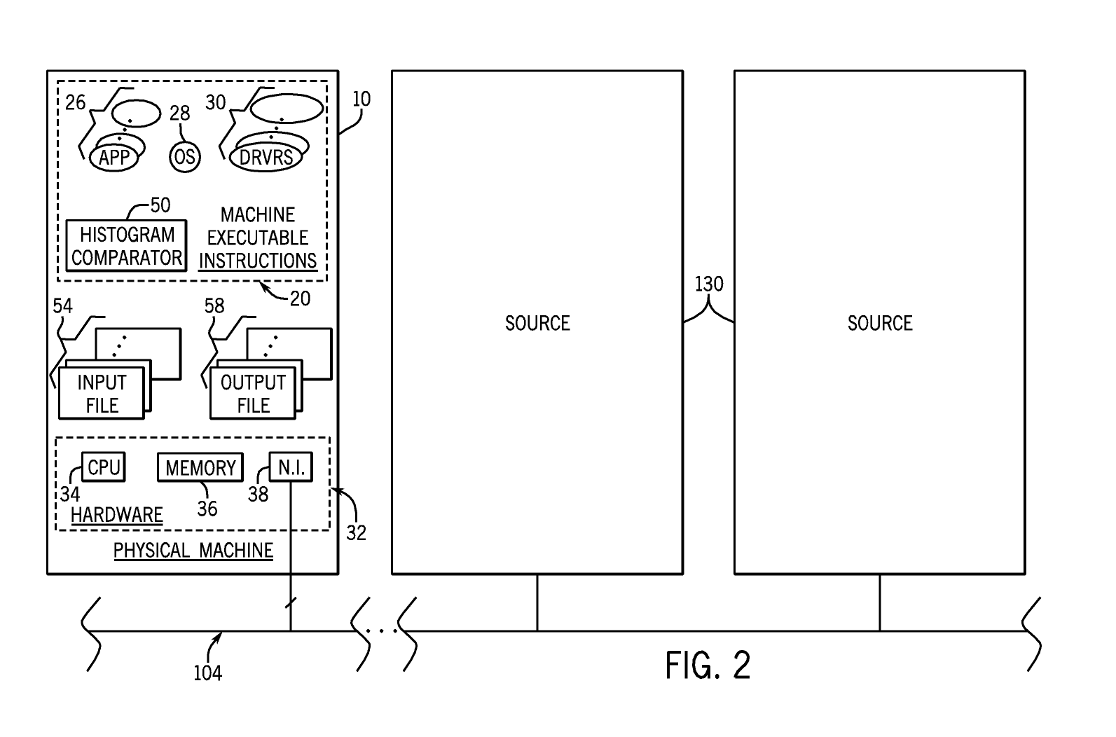

Referring to FIG. 2, as a non-limiting example, the systems and techniques that are disclosed herein may be implemented in a computer system 4 that includes one or multiple physical machines 10. In this context, a “physical machine” indicates that the machine is an actual machine made up of executable program instructions and hardware. Examples of physical machines include computers (e.g., application servers, storage servers, web servers, etc.), communications modules (e.g., switches, routers, etc.) and other types of machines. The physical machine(s) may be located within one cabinet (or rack); or alternatively, the physical machine(s) may be located in multiple cabinets (or racks).

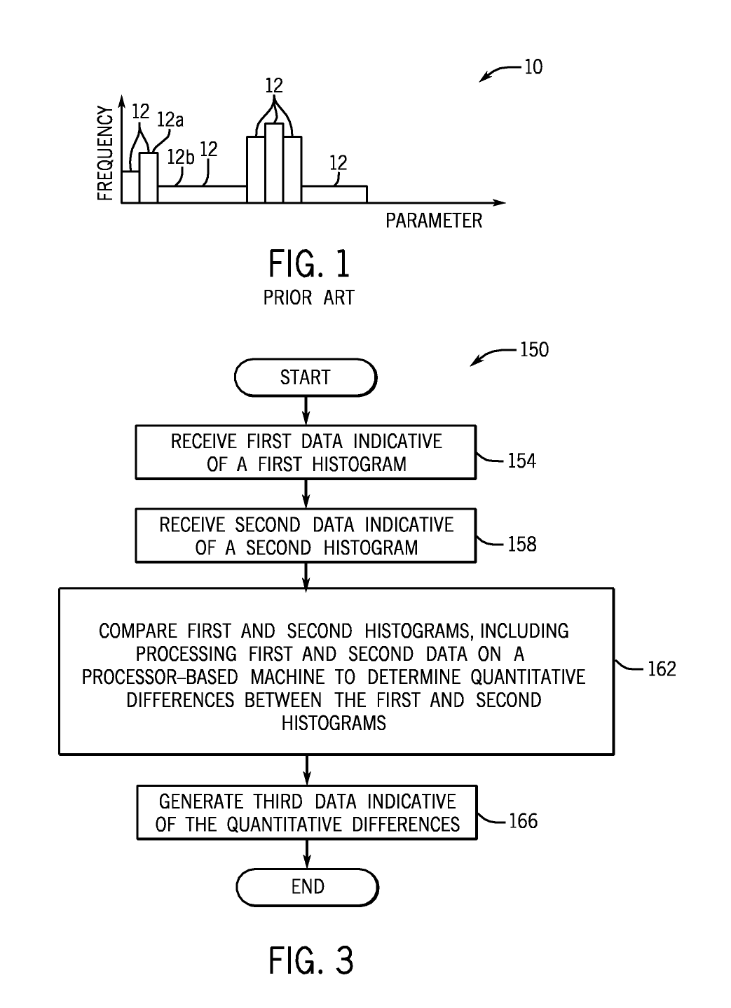

As depicted in FIG. 1, the physical machine 10 may be interconnected by a network 104 to one or multiple histogram data sources 130 (DBMSs, for example). Examples of the network 104 include a local area network (LAN), a wide area network (WAN), the Internet, or any other type of communications link. The network 104 may also include system buses or other fast interconnects.

In accordance with a specific example described herein, the physical machine 10 contains machine executable program instructions 20 and hardware 32 that executes the instructions 20 for purposes of comparing histograms and generating data indicative of this comparison. In this manner, the data allows a user to determine the extent that the distribution statistics of the continuous variable have changed. Although FIG. 2 depicts the physical machine 10 as being separate from the source(s) 130, the physical machine 10 may include a histogram data source, in accordance with other example implementations of the invention. Moreover, in accordance with other example implementations of the invention, the physical machine 10 may be used to compare histograms that are not generated or used by a DBMS. Thus, many variations are contemplated and are within the scope of the appended claims.

It is noted that in other implementations, the architecture used to analyze the histograms may include additional physical machines 10 in addition to the physical machine 10 that is depicted in FIG. 2. Thus, all or part of the described histogram comparison may be implemented on a single physical machine 10 or on more than two physical machines 10, depending on the particular implementation.

The architecture that is depicted in FIG. 2 may be implemented in an application server, a storage server farm (or storage area network), a web server farm, a switch or router farm, other type of data center, and so forth. Additionally, although the physical machine 10 is depicted in FIG. 2 as being contained within a box, it is noted that a physical machine 10 may be a distributed machine having multiple nodes, which provide a distributed and parallel processing system.

As depicted in FIG. 2, in some implementations, the machine executable instructions 20 may include one or multiple applications 26, an operating system 28 and one or multiple device drivers 30 (which may be part of the operating system 28). In general, the machine executable instructions 20 are stored in storage, such as in a memory 36 of the physical machine 10. In general, the machine executable instructions 20 may be stored in a non-transitory medium or non-transitory media, such as in system memory, in a semiconductor memory, in removable storage media, in optical storage, in magnetic storage, in non-removable storage media, in storage separate (local or remote) from the physical machine 10, etc., depending on the particular implementation.

The hardware 32 includes one or multiple processors that execute the machine executable instructions 20, such as one or multiple central processing unit (CPUs) 34 (one CPU 34 being depicted in FIG. 1 for purposes of a non-limiting example), or one or multiple processing cores of the CPU(s) 34. The hardware 32 may also include a system memory 36 and a network interface 38.

In accordance with some implementations, the processor(s) may also execute a set of machine executable instructions, called a “histogram comparator 50,” for purposes of causing the physical machine 10 to, in response to input data provided by a user, receive input files 54 that are indicative of respective histograms and compare these histograms to generate one or multiple corresponding output files 58, which contain data indicative of the comparison.

More particularly, referring to FIG. 3 in conjunction with FIG. 2, in accordance with example implementations, under control of the histogram comparator 50, the physical machine 10 may perform a technique 150 for purposes of comparing histograms. Pursuant to the technique 150, the physical machine 10 receives (block 154) first data indicative of a first histogram and receives (block 158) second data indicative of a second histogram. The physical machine 10 compares the first and second histograms, which includes processing the first and second data to determine quantitative differences between the first and second histograms, pursuant to block 162; and the physical machine 10 generates third data indicative of the results of the quantitative differences, pursuant to block 166.

As described herein, the histogram comparisons may be by bins (especially for the case of lossy comparison data being used) or by content, when all of the data used to generate the histograms is available.

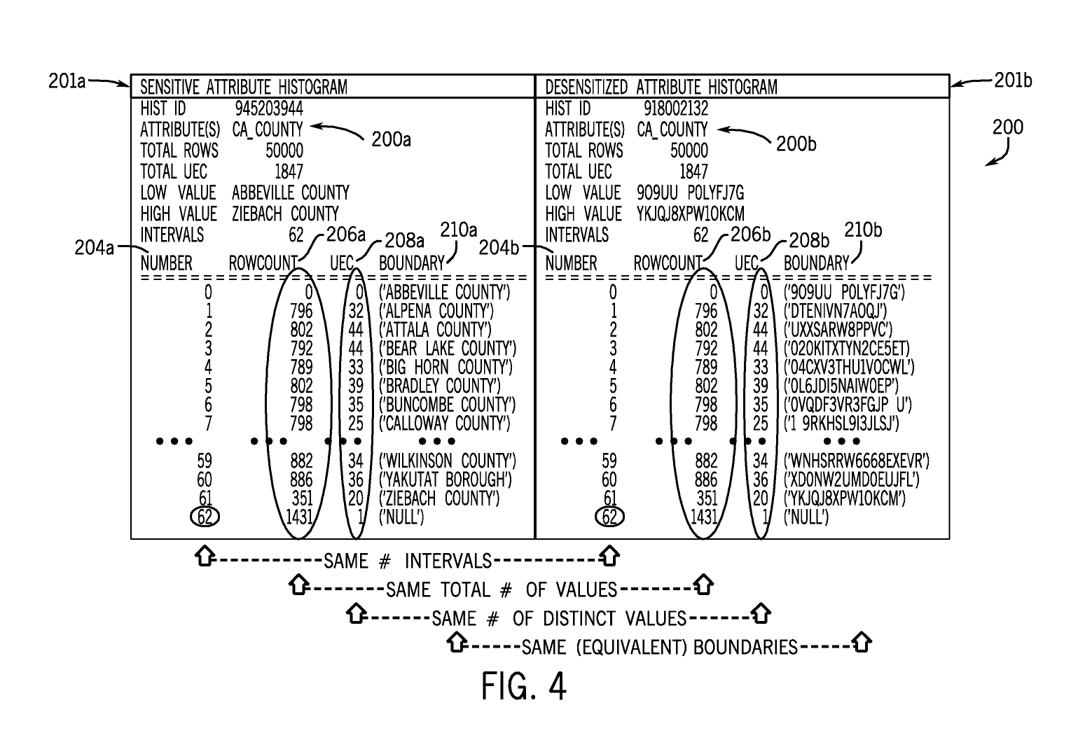

In accordance with some example implementations, the histogram comparison produces an output file 58 that indicates a comparison of the two histograms. As a non-limiting example, referring to FIG. 4 in conjunction with FIG. 2, the comparison may be in the form of a table 200, which, similar to other comparisons that are disclosed herein may be graphically displayed on a display (not shown) of the physical machine 10. The table 200 depicts the comparison of a more recently generated attribute histogram for an attribute 200b (the CA_COUNTY attribute for this example) with an older attribute histogram for the corresponding more recent CA_COUNTY attribute 200a. For this example, the input file 54 that corresponds to the newer histogram stores desensitized values, whose identities have been masked for protection purposes. As such the CA_COUNTY attribute 200b for this example contains de-sensitized values, and the values of the CA_COUNTRY attribute 200a, for this example, are the original ones (i.e., not de-sensitized). The physical machine 10 and/or user has access to an encoding/map to correlate the corresponding values of the histograms.

For the exemplary table 200 that is depicted in FIG. 4, the attributes 200a and 200b compared (CA_COUNTY before and after desensitization) are arranged in columns 201a (for the older histogram) and 201b (for the newer histogram), which depicts subcolumns 204a (for the older histogram) and 204b (for the newer histogram) depicting bin identifier numbers; subcolumns 206a (for the older histogram) and 206b (for the newer histogram) depicting the number of values (total frequency) in each bin; subcolumns 208a (for the older histogram) and 208b (for the newer histogram) depicting the number of different values inside each bin (also called “unique entry counts (UECs)”); and subcolumns 210a (for the older histogram) and 210b (for the newer histogram), depicting the first value of each bin.

For the specific example of FIG. 4, the two attribute histograms being compared are equal, as the two histograms have the same number of bins, the same total number of values in each bin, the same number of distinct values in each bin and the same boundary or first value of each bin. However, in accordance with example implementations of the invention, the physical machine 10 under the execution of the histogram comparator 50, performs a further analysis of the two histograms, which allows the user to further analyze whether the underlying statistical distribution of the continuous variable has changed.

For example, in accordance with some implementations, the physical machine 10, under control of the histogram comparator 50, compares the histograms on a bin by bin basis. To perform this analysis, the physical machine 10 compares corresponding records of the input files 54 which contain the histograms data to generate corresponding records in an output file 58, which indicate the differences. The output file 58 may indicate either a detailed comparison result for each pair of corresponding records that are compared; or alternatively, the output file 58 may indicate only the differences.

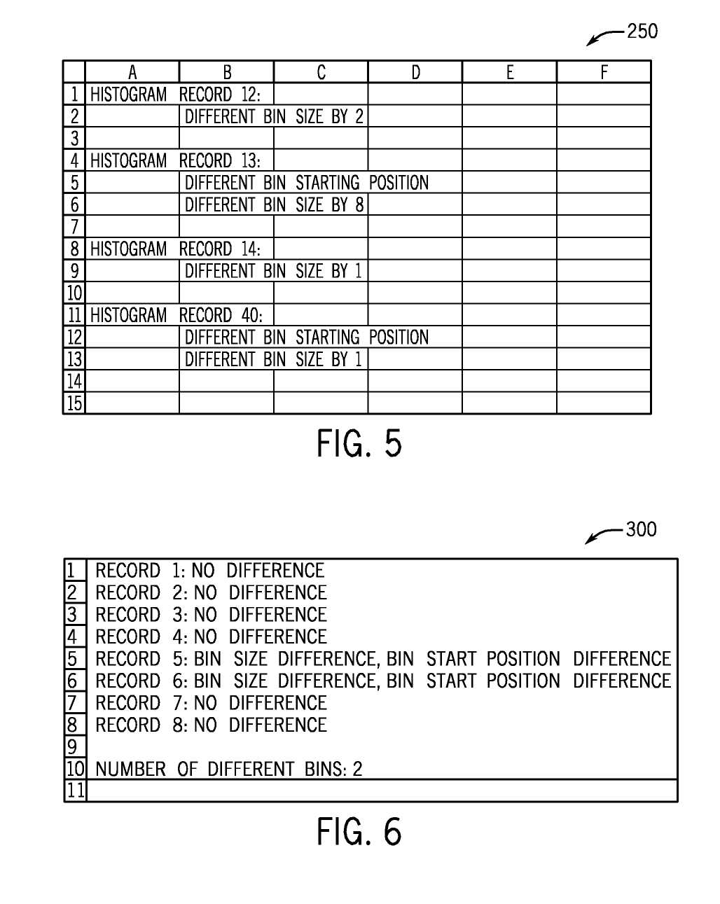

As a more specific example, FIG. 5 illustrates a comparison 250 indicated by an output file 58, in accordance with some implementations. The comparison 250 shows differences in bin sizes, as well as differences in the bin starting positions from corresponding histogram record numbers 12, 13, 14 and 40. For this specific example, corresponding histogram record numbers 12 have a bin size difference of two; corresponding histogram record numbers 13 have different bin starting positions and a bin size difference of eight; corresponding histogram record numbers 14 have a bin size difference of one; and corresponding histogram record numbers 40 has different bin starting positions and a bin size difference of one. Thus, the comparison 250 details the differences found and presents a bin-based comparison, which shows the differences in the aspects between the bins that have the same relative positions in the histograms (where the positions are sequential).

As another example, FIG. 6 depicts an exemplary comparison 300 indicated by an output file 58, which is a higher level difference comparison that highlights which bins are different and which bins are equal. For this example, corresponding bins in record numbers 1, 2, 3, 4, 7 and 8 of the histograms are the same; corresponding bins in record numbers 5 have different bin sizes and starting positions; and corresponding bins in record numbers 6 have different bin sizes and starting positions. The comparison 300 also indicates the number (two) of different bins.

Referring to FIG. 2, in accordance with example implementations of the invention, the physical machine 10, under the control of the histogram comparator 50, retrieves the input files 54 for the histograms being compared. The input files 54 may or not be provided by a DBMS, as a DBMS may or may not by the source of the histograms being compared. For the non-limiting example of when the DBMS is the source, the histogram comparator 50 may read the histogram directly from previously-provided input files 54 (such as the case when the DBMS produces such a file with the histogram), or the histogram comparator 50 may, for example, communicate an appropriate command to the appropriate DBMS to request the input file 54 for each of the requested histograms. The sources of the histograms may therefore vary, and as such the formats of the corresponding input files 54 may vary. Therefore, the histogram comparator 50, in accordance with some example implementations of the invention, includes a set of readers, that are configured to, when executed by the physical machine 10, cause the machine 10 to understand the different output formats and extract the histogram information from the result sets or files, which are produced by the various potential histogram sources.

As a non-limiting example for the scenario in which a DBMS is the source of the histogram data, a given DBMS may return a result set just as for queries, and another DBMS may return a file in which the file contains histogram data along with data that is not histogram related. As a more specific example, the Neoview DBMS has a command to export the database definition (called the “DDL”) into a file; and this file includes the histogram information on a per interval, or bin, basis (i.e., information for every bin in the histogram) along with the definition of database tables and other database objects.

After the physical machine 10 receives the input files 54 for the histograms to be compared, the physical machine 10 compares each of the aspects mentioned above between the histograms. In accordance with some example implementations, the physical machine 10, under the control of the histogram comparator 50, generates temporal files by restructuring the input files 54 into a more suitable format for performing the histogram comparison. More specifically, in accordance with some example implementations, the physical machine 10 restructures each of the input files 54 into a format in which one bin is described per record in terms of a bin starting element, or value; number of bin values; and number of distinct values. Other variations are contemplated and are within the scope of the appended claims. Once restructured into this format in the temporal files, the physical machine 10 compares the corresponding temporal files to produce the output files 58.

In accordance with some example implementations, physical machine 10, under the control of the histogram comparator 50, produces a graphical user interface (GUI), which appears on a monitor, or display (not depicted in FIG. 2), of the physical system 10. In general, the GUI allows the user to indicate whether a histogram source is a DBMS or a file. If it is a DBMS the user indicates which databases to use; the columns or group of columns whose histograms are to be compared; and whether those columns need to be refreshed in their statistics (i.e., if the histograms need to be recomputed in case they are obsolete); In any case, the user indicates whether a bin-based comparison or a content-based comparison is to be employed.

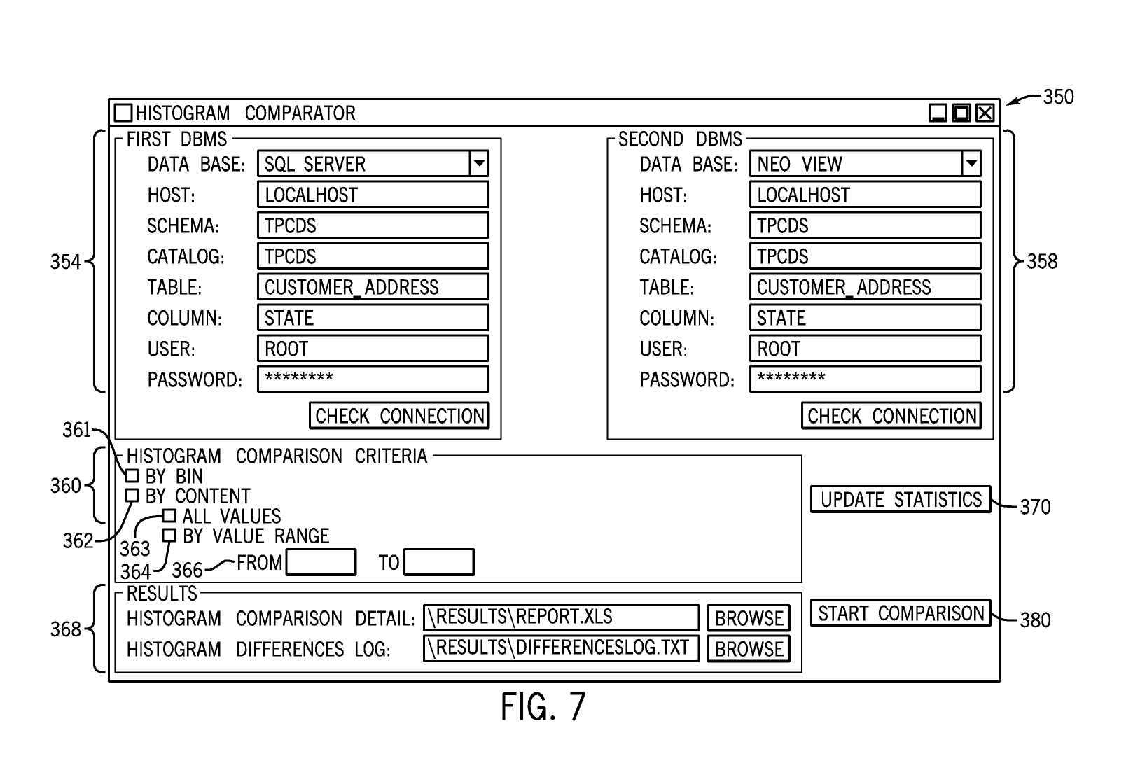

FIG. 7 depicts an exemplary GUI 350 in accordance with some example implementations for the case when the histogram sources are DBMSs. As shown, the GUI 350 includes fields 354 to select one histogram source and fields 358 to select the other histogram source (which could be the same or another source possibly containing another version of the same histogram, for example) for sending them the commands to get the desired histograms for the comparison. Moreover, the GUI 350 allows selection of the histogram comparison criteria through or content-based comparison criteria selected via fields 360. More specifically, a “By Bin” selector 361 allows the user to configure comparison of the histograms by bin and thus, may involve the comparison of histograms which were generated by lossy compression-generated data; and a “By Content” selector 362 that allows the user to view a comparison of lossless content values for all values (via selector 363) or only for a certain value range (via selector 364 and value range fields 366).

The GUI 350 also includes fields 368 for purposes of specifying the location of such output files 58, as a location of the histogram comparison detail file as well as a location of the histogram difference log. As also shown in FIG. 7, the GUI 350 includes a selector 370 for purposes of updating the underlying statistics of the histograms as well as a selector 380 to start the histogram comparison. It is noted that the GUI may have other formats and fields and perform other functions, in accordance with other example implementations.

Regarding the selection of the histogram comparison criteria via fields 360, the histogram comparator 50 allows the option of performing the comparison by the bin, in which case the histogram comparator 50 uses the histogram information returned by the histogram data source(s) 130 (upon execution of the command send by the physical machine 10), which may be lossy data. However, the fields 360 also permit the option of comparing lossless histogram data by content. For these example implementations, when the user selects the “By Content” selector 362, the physical machine 10 communicates the appropriate query(ies) to the DBMS(s) to retrieve all of the column (i.e., attribute) values. As a non-limiting example, a query may be as follows:
SELECT column, count(*)
FROM table
GROUP BY (column)
   The above-described query returns the number of occurrences for each distinct value of the column. These values are written to a file and aligned side by side with the values of the other column to be compared.

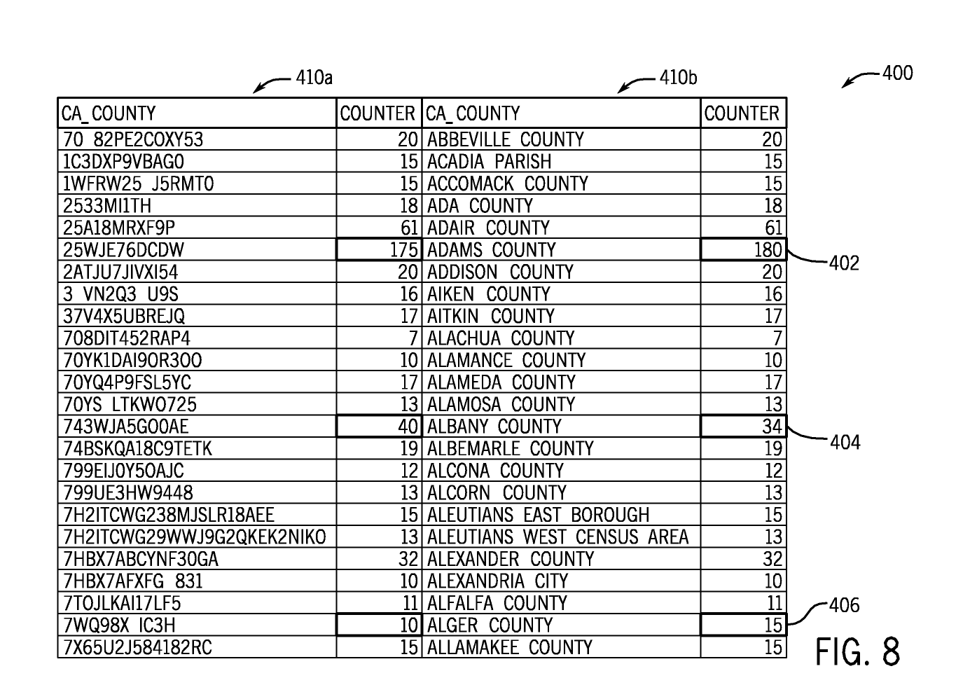

As a non-limiting example of a comparison by content, FIG. 8 depicts a side by side column value comparison 400 indicated by an output file 58, in accordance with some example implementations. As shown, the comparison 400 includes a first column 410a of all the values (i.e., lossless histogram) from a desensitized attribute, and a second column 410b of all the original sensitive values (i.e., lossless histogram) of the attribute. The columns include corresponding count value columns, which allow a side by side comparison of the corresponding count values. As shown in this comparison, certain rows 402, 404 and 406 for this example have different count values.

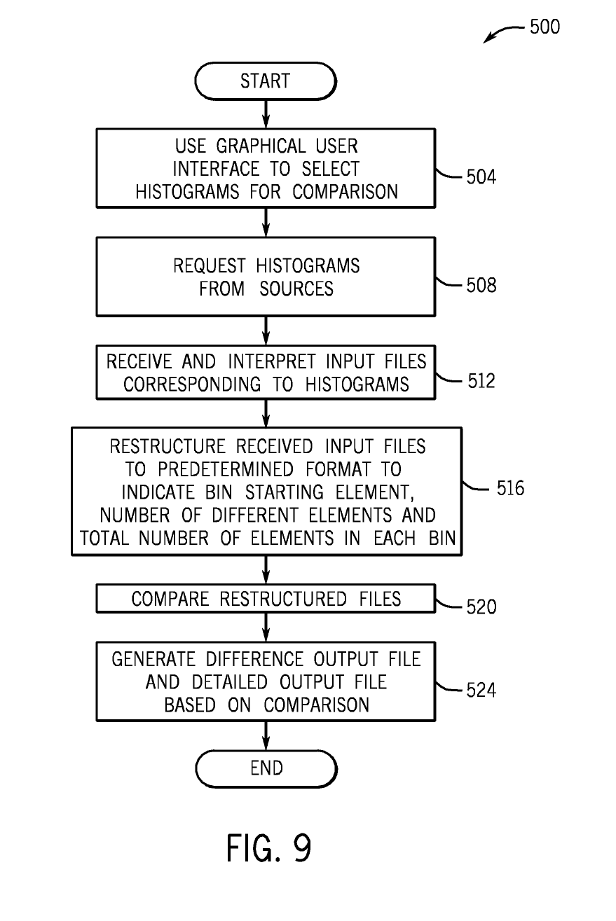

Referring to FIG. 9 in conjunction with FIG. 2, to summarize, in accordance with example implementations, a technique 500 may be used for purposes of comparing various aspects of histograms according to example implementations. Pursuant to the technique 500, a computer-generated GUI is used (block 504) to select histograms for comparison and data pertaining the requested histograms is requested from the appropriate source(s) (DBMS(s), for example), pursuant to block 508. The corresponding files are then received and interpreted (block 512); and these files may then be reconstructed (block 516) to a predetermined format, which indicate the bin starting value, the number of different values and the total number of values in each bin. The reconstructed files are then compared (block 520) and corresponding difference and detailed files are then generated, pursuant to block 524 based on the comparison.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
receiving first data indicative of a first histogram;
receiving second data indicative of a second histogram;
comparing the first and second histograms on a processor-based machine, the comparing comprising processing the first and second data on the machine to determine quantitative differences between the first and second histograms; and
generating third data indicative of the quantitative differences.

2. The method of claim 1, wherein the first histogram comprises bins having starting positions and values, the second histogram comprises bins having starting positions and values, and act of processing comprises analyzing the first and second data to identify differences between values in the starting positions, a number of distinct values in each bin and sizes of the bins.

3. The method of claim 1, wherein the first data indicates a first set of values supporting the first histogram, and the second data indicates a second set of values supporting the second histogram, and the method further comprising processing third lossless data indicative of all count values originating the first histogram and fourth data lossless data indicative of all count values originating the second histogram to identify differences in the frequencies of said all count values.

4. The method of claim 1, wherein the first and second data is provided by at least one source, the method further comprising selecting at least one reader to access at least one of the first data and the second data based on said at least one source.

5. The method of claim 1, further comprising:
providing a user interface to allow selection of the first and second histograms for comparison.

6. The method of claim 1, wherein the act of comparing comprises:
restructuring the first and second data according to relative positions of bins of the first and second histograms and using a starting value of each bin in the first and second histograms, a number of distinct values in each bin of the first and second histograms and a number of values in each bin of the first and second histograms to generate corresponding restructured first and second data; and
processing the first and second restructured data on the machine to indicate the quantitative differences between the first and second histograms.

7. The method of claim 1, further comprising:
displaying an image indicative of the third data.

8. An article comprising a processor readable storage medium to store instructions that when executed by at least one processor cause said at least one processor to:
receive first data indicative of a first histogram;
receive second data indicative of a second histogram;
compare the first and second histograms, the comparison comprising processing the first and second data on the machine to determine quantitative differences between the first and second histograms; and
generate third data indicative of the quantitative differences.

9. The article of claim 8, wherein the first histogram comprises bins having starting positions and values, the second histogram comprises bins having starting positions and values, and the storage medium storing instructions that when executed by said at least one processor causes said at least one processor to analyze the first and second data to identify differences in values in the starting positions, a number of distinct values in each bin and sizes of the bins.

10. The article of claim 8, wherein the first data indicates a first set of values supporting the first histogram, the second data indicates a second set of values supporting the second histogram, and the storage medium storing instructions that when executed by said at least one processor causes said at least one processor to process third lossless data indicative of all count values originating the first histogram and fourth data lossless data indicative of all count values originating the second histogram to identify differences in the frequencies of said all count values.

11. The article of claim 8, the storage medium storing instructions that when executed by said at least one processor cause said at least one processor to provide a user interface to allow selection of the first and second histograms for comparison.

12. The article of claim 8, the storage medium storing instructions that when executed by said at least one processor cause said at least one processor to:
restructure the first and second data according to relative positions of bins of the first and second histograms and using a starting value of each bin in the first and second histograms, a number of distinct values in each bin of the first and second histograms and a number of values in each bin of the first and second histograms to generate corresponding restructured first and second data; and
compare the first and second restructured data.

13. The article of claim 8, the article storing instructions that when executed by said at least one processor cause said at least one processor to select a reader to access the first data based on a source that provides the first data.

14. A system comprising:
a memory to store first data indicative of a first histogram and second data indicative of a second histogram; and
a processor-based comparator to process the first and second data to determine quantitative differences between the first and second histograms and generate third data indicative of the quantitative differences.

15. The system of claim 14, wherein the first histogram comprises bins having starting positions and values, the second histogram comprises bins having starting positions and values, and the comparator is adapted analyze the first and second data to identify differences in the starting positions, a number of distinct values in each bin and sizes of the bins.

16. The system of claim 14, wherein the first data indicates a first set of values supporting the first histogram, the second data indicates a second set of values supporting the second histogram, and the comparator is adapted to process third lossless data indicative of all count values originating the first histogram and fourth data lossless data indicative of all count values originating the second histogram to identify differences in the frequencies of said all count values.

17. The system of claim 14, further comprising:
a processor-based user interface to allow a user to select the first and second histograms for comparison.

18. The system of claim 14, wherein the comparator is adapted to:
restructure the first and second according to relative positions of bins of the first and second histograms and using a starting value of each bin in the first and second histograms, a number of distinct values in each bin of the first and second histograms and a number of values in each bin of the first and second histograms to generate corresponding restructured first and second data; and
compare the restructured first and second data.

19. The system of claim 14, wherein the third data is indicative of at least one of the number of bins for the first and second histograms, the number of different values inside each bin of each of the first and second histograms, and the number of total values inside each bin of the first and second histograms.

20. The system of claim 14, wherein the comparator is adapted to:
retrieve fourth data indicative of distinct values for the first histogram;
retrieve fifth data indicative of distinct values for the second histogram; and
highlight differences between counts of the values.
